(19) United States
(12) Patent Application Publication
(10) Pub. No.: US 2016/0167023 A1
(43) Pub. Date: Jun. 16, 2016

(54) ZPGM Catalyst Including Co-Mn-Fe and Cu-Mn-Fe Materials for TWC Applications

(71) Applicants: Zahra Nazarpoor, Camarillo, CA (US); Oguzhan S. Yaglidere, Oxnard, CA (US); Stephen J. Golden, Santa Barbara, CA (US)

(72) Inventors: Zahra Nazarpoor, Camarillo, CA (US); Oguzhan S. Yaglidere, Oxnard, CA (US); Stephen J. Golden, Santa Barbara, CA (US)

(73) Assignee: Clean Diesel Technologies, Inc., Ventura, CA (US)

(21) Appl. No.: 14/567,836

(22) Filed: Dec. 11, 2014

(51) Int. Cl. B01J 23/889; B01J 35/00; B01J 37/08; B01D 53/94; B01J 23/10; B01J 23/00

(52) U.S. Cl. CPC B01J 23/8892; B01J 23/10; B01J 23/005; B01J 37/08; B01D 53/945; B01J 35/0006; B01D 2255/2066; B01D 2255/20715; B01D 2255/405; B01D 2255/908; B01D 2255/65; B01D 2255/20738; B01D 2255/20746; B01D 2255/2073; B01D 2255/20761

(57) ABSTRACT

Variations of bulk powder catalyst materials, including a plurality of formulations for stoichiometric and non-stoichiometric Co_Mn—Fe spinel and Cu—Mn—Fe spinel, which may be prepared by incipient wetness method, employing variations of molar ratio and general formulation (CoₓFe_{z}Mn_{2z})_{3-δ}O₄, and Co₁₋ₓMnₓFe₂O₄ spinel supported on doped ZrO₂ support oxide. According to principles in present disclosure, a plurality of formulations for fine grain bulk powder compositions of Cu—Mn—Fe spinel with general formulation of CuₓMn_{y}Fe_{z}O₄, may provide solutions for enhanced NOx, CO, and HC conversion performance for TWC applications, employing ZPGM materials for a plurality of TWC applications. Additionally, these types of ternary ZPGM fine grain bulk powder spinel compositions may have a cost effective manufacturing advantage.

### BACKGROUND

1. Field of the Disclosure

The present disclosure may provide Zero-PGM (ZPGM) catalyst materials, which may include stoichiometric or non-stoichiometric Co_Mn—Fe and Cu—Mn—Fe spinels in the form of fine grain powder to use for three-way catalyst (TWC) applications.

2. Background Information

TWC converters exhibit good catalytic activities and long life, which may be produced by combinations of noble metals using platinum group metals (PGM) materials. However, most TWC systems may present drawbacks of different natures. In some applications, these catalysts may operate at or near stoichiometric condition, and may not initiate the removal of toxic components included in exhaust gas until a relatively high temperature level is attained, and thus the catalyst may fail in removing/converting the toxic components at desired level of temperature from internal combustion engines.

Therefore, demand has emerged for material compositions and formulations capable of achieving the required TWC catalytic performance in a variety of environments, which are substantially free of PGM, because of its small market circulation volume, constant fluctuations in price, and constant risk to stable supply, amongst others.

According to the foregoing reasons, there is a need for catalyst material compositions that does not require platinum group metals, which are capable to achieve similar o better efficiency as prior art catalysts used for TWC applications. These materials may be able to provide improved catalytic performance across a range of temperatures and operating conditions, and can be manufactured cost-effectively.

### SUMMARY

The present disclosure may provide Zero-PGM (ZPGM) catalysts, which may include stoichiometric or non-stoichiometric Co_Mn—Fe and Cu—Mn—Fe spinels on doped Zirconia support oxide in the form of fine grain powder, to develop suitable ZPGM catalysts for TWC applications.

According to embodiments in present disclosure, a plurality of ternary ZPGM catalyst samples may be prepared using variations of Co—Fe—Mn and Cu_Fe—Mn spinels on doped Zirconia support oxide, which may be prepared by incipient wetness (IW) method or any other synthesis methods as known in the art. Stoichiometric or non-stoichiometric Co—Fe—Mn spinels may be prepared at different molar ratios according to formulation (CoₓFe_{z}Mn_{2z})_{3δ}O₄ where Fe/Mn=0.5, x+3z=1, and 0≦δ≦0.2. In present disclosure, disclosed Co—Fe—Mn spinel systems may be supported on Praseodymium-Zirconia support oxide, which may be subsequently dried, calcined, and ground to fine grain bulk powder.

According to another embodiment in present disclosure, ternary ZPGM catalyst samples of disclosed Co_Mn—Fe on doped Zirconia support oxide, may be prepared by incipient wetness (IW) method or any other synthesis methods as known in the art. Stoichiometric or non-stoichiometric Co_Mn—Fe spinels may be prepared at different molar ratios according to formulation Co₁₋ₓMnₓFe₂O₄ where 0≦x≦1. In present disclosure, disclosed Co_Mn—Fe spinel systems may be supported on Praseodymium-Zirconia support oxide, which may be subsequently dried, calcined, and ground to fine grain bulk powder.

According to another embodiment in present disclosure, ternary ZPGM catalyst samples of disclosed Cu—Mn—Fe on doped Zirconia support oxide, may be prepared by incipient wetness (IW) method or any other synthesis methods as known in the art. Stoichiometric or non-stoichiometric Cu—Mn—Fe spinels may be prepared at different molar ratios according to formulation CuₓMn_{y}Fe_{z}O₄ where x+y+z=3. In present disclosure, disclosed Cu—Mn—Fe spinel systems may be supported on Praseodymium-Zirconia support oxide, which may be subsequently dried, calcined, and ground to fine grain bulk powder.

Disclosed ternary catalyst systems including Co_Mn—Fe, and Cu_Fe—Mn spinels may be verified preparing fine grain bulk powder samples for each of the catalyst formulations and configurations, object of present disclosure, to determine its influence on TWC performance of ZPGM catalysts.

The NO/CO cross over R-value of prepared samples, per ternary spinel systems in present disclosure, may be determined and compared by performing isothermal steady state sweep test, which may be performed at a selected inlet temperature, using an 11-point R-value from rich condition to lean condition at a plurality of space velocities. Results from isothermal steady state test may be compared to show the effect that different ternary spinel system fine grain bulk powders may have on TWC performance, particularly under close to stoichiometric condition. Additionally, catalytic performance of fine grain bulk powder samples including Co—Fe—Mn spinel and Cu_Fe—Mn spinel may be qualitatively compared for each group of ternary spinel systems separately.

According to principles in present disclosure, fine grain bulk powder materials with compositions exhibiting a high level of catalytic activities, may be used for a plurality of TWC applications. From a catalyst manufacturer's viewpoint, may be an essential advantage, given the economic factors involved when substantially PGM-free materials are used for the manufacture of fine grain bulk powder catalyst materials capable to provide similar or improved TWC performance.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 illustrates catalyst performance for fine grain bulk powder samples prepared per Example #1 and formulations in Table 1, under isothermal steady state sweep condition at inlet temperature of about 450° C. and space velocity (SV) of about 40,000 h⁻¹, according to an embodiment.

FIG. 2 depicts catalyst performance comparison for fine grain bulk powder catalyst samples prepared per Example #1 and formulations in Table 1, under isothermal steady state sweep condition, at inlet temperature of about 450° C. and SV of about 40,000 h⁻¹, according to an embodiment. FIG. 2A shows comparison of HC conversion levels for Co—Fe—Mn spinels on doped Zirconia support oxide. FIG. 2B illustrates comparison of NO_{X} conversion levels for Co—Fe—Mn spinels on doped Zirconia support oxide.

FIG. 3 depicts results of steady state sweep test for conversion performance of CO, HC, and NO, employing fine grain bulk powder samples prepared per Example #2 and formulations in Table 2, under isothermal steady state sweep condition at inlet temperature of about 450° C. and space velocity (SV) of about 40,000 h⁻¹, according to an embodiment.

FIG. 4 illustrates catalyst performance comparison for fine grain bulk powder catalyst samples prepared per Example #2 and formulations in Table 2, under isothermal steady state sweep condition, at inlet temperature of about 450° C. and SV of about 40,000 h⁻¹, according to an embodiment. FIG. 4A shows comparison of HC conversion levels for Cu_Fe—Mn spinels on doped Zirconia support oxide. FIG. 4B shows comparison of NO_{X} conversion levels for Cu_Fe—Mn spinels on doped Zirconia support oxide.

FIG. 5 shows catalyst performance comparison for fine grain bulk powder catalyst samples of Co_{0.5}Mn_{0.5}Fe_{2.0}O₄ spinel and Cu_{1.0}Fe_{0.5}Mn_{1.5}O₄ spinel, both on doped Zirconia support oxide, under isothermal steady state sweep condition, at inlet temperature of about 450° C. and SV of about 40,000 h⁻¹, according to an embodiment. FIG. 5A shows comparison of HC conversion levels for Cu_{1.0}Fe_{0.5}Mn_{1.5}O₄ spinel and Co_{0.5}Mn_{0.5}Fe_{2.0}O₄ spinels, both on doped Zirconia support oxide. FIG. 5B illustrates comparison of NO_{X} conversion levels for Cu_{1.0}Fe_{0.5}Mn_{1.5}O₄ spinel and Co_{0.5}Mn_{0.5}Fe_{2.0}O₄ spinels, both on doped Zirconia support oxide.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Incipient wetness” refers to the process of adding solution of catalytic material to a dry support oxide powder until all pore volume of support oxide is filled out with solution and mixture goes slightly near saturation point.

“Calcination” refers to a thermal treatment process applied to solid materials, in presence of air, to bring about a thermal decomposition, phase transition, or removal of a volatile fraction at temperatures below the melting point of the solid materials.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### DESCRIPTION OF THE DRAWINGS

The present disclosure provides a plurality of spinel fine grain bulk powder material compositions including Co_Mn—Fe spinel and Cu—Mn—Fe spinel, prepared at different molar ratios supported on doped-Zirconia support oxide, to develop suitable ZPGM catalyst materials capable of providing improved catalytic activities. Aspects that may be treated in present disclosure, may show improvements for overall catalytic conversion capacity for a plurality of ZPGM catalysts, which may be suitable for TWC applications.

Fine Grain Bulk Powder Catalyst Material Composition and Preparation

In the present disclosure, Zero-PGM material compositions in form of fine grain bulk powder may be prepared from stoichiometric and non-stoichiometric Co—Fe—Mn and Cu_Fe—Mn spinel compositions at different molar ratios, supported on doped Zirconia support oxide, via incipient wetness (IW) method as known in the art.

Preparation of fine grain bulk powder catalyst samples may begin by preparing the solution of Co—Fe—Mn or Cu_Fe—Mn spinels to make aqueous ZPGM solution of three metal precursors. Ternary solutions of Co—Fe—Mn or Cu_Fe—Mn spinels may be prepared by mixing the appropriate amount of Co nitrate solution Co(NO₃)₂, or Cu nitrate solution (Cu(NO₃)₂ with Fe nitrate solution (Fe(NO₃)₃) and Mn nitrate solution (Mn(NO₃)₂), with water to make solution at different molar ratios, according to general formulations in Table 1 or Table 2, where disclosed ternary spinel systems in present disclosure are shown. Accordingly, solution of metal nitrates may be subsequently added drop-wise to doped Zirconia powder via IW method. Then, mixtures of Co—Fe—Mn or Cu—Mn—Fe spinels on doped Zirconia support oxide may be dried and calcined at about 800° C. for about 5 hours. Subsequently, calcined materials of Co—Fe—Mn or Cu—Mn—Fe spinels on doped Zirconia may be ground to fine grain bulk powder for preparation of catalyst samples.

Bulk powder of ternary Co—Fe—Mn and Cu_Fe—Mn spinels on support oxide may be prepared via other synthesis methods known in the art, such as Co-precipitation, Impregnation, Sol-Gel method and any other methods used for preparation of powder samples.

Isothermal Steady State Sweep Test Procedure

The isothermal steady state sweep test may be carried out employing a flow reactor at inlet temperature of about 450° C., and testing a gas stream at 11-point R-values from about 2.00 (rich condition) to about 0.80 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NO_{R}, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

The following examples are intended to illustrate, but not to limit the scope of the present disclosure. It is to be understood that other procedures known to those skilled in the art may alternatively be used.

### EXAMPLES

### Example #1

### Co—Fe—Mn Spinel on Doped ZrO₂ Support Oxide

Example #1 describe preparation instructions of disclosed fine grain powder samples including Co—Fe—Mn spinels supported on doped ZrO₂ support oxide via IW method, according to a plurality of molar ratios, as shown in Table 1, based in general formulation (CoₓFe_{z}Mn_{2z})_{3-δ}O₄, where Fe/Mn=0.5, x+3z=1, and 0≦X≦0.2 supported on Pr₆O₁₁-ZrO₂ support oxide, and general formulation Co₁₋ₓMnₓFe₂O₄ spinel where 0≦X≦1 supported on Pr₆O₁₁-ZrO₂ support oxide.

TABLE 1

| | |
|---|---|
| SPINEL | SUPPORT OXIDE |
| COMPOSITION | COMPOSITION |

SPINEL FORMULATION: (CoₓFe_{z}Mn_{2z})_{3-δ}O₄
in which Fe/Mn = 0.5 and x + 3z = 1

| | |
|---|---|
| Co_{0.3}Fe_{0.9}Mn_{1.5}O₄ | Pr₆O₁₁—ZrO₂ |
| Co_{0.6}Fe_{0.8}Mn_{1.6}O₄ | Pr₆O₁₁—ZrO₂ |
| Co_{1.0}Fe_{0.7}Mn_{1.3}O₄ | Pr₆O₁₁—ZrO₂ |

SPINEL FORMULATION: Co₁₋ₓMnₓFe₂O₄
in which 0 ≦ X ≦ 1

| | |
|---|---|
| Co_{0.5}Mn_{0.5}Fe_{2.0}O₄ | Pr₆O₁₁—ZrO₂ |
| Co_{0.8}Mn_{0.2}Fe_{2.0}O₄ | Pr₆O₁₁—ZrO₂ |

Example #1 may illustrate preparation of fine grain bulk powder catalyst samples including Co—Fe—Mn spinels supported on Pr₆O₁₁—ZrO₂ support oxide via IW method.

Preparation of fine grain bulk powder catalyst samples may begin by preparing the Co—Fe—Mn solution by mixing the appropriated amount of Co nitrate solution Co(NO₃)₂, Fe nitrate solution (Fe(NO₃)₃) and Mn nitrate solution (Mn(NO₃)₂), with water to make solution at different molar ratios, according to general formulations in Table 1, where disclosed Co—Fe—Mn spinels are shown. Then, solution of Co, Fe, and Mn nitrates may be added drop-wise to Pr₆O₁₁—ZrO₂ support oxide powder via IW method. Subsequently, mixture of Co, Fe, and Mn spinels on Pr₆O₁₁—ZrO₂ support oxide may be dried at 120 C over night and calcined at about 800° C. for about 5 hours, and then ground to fine grain bulk powder for preparation of catalyst samples.

Results from isothermal steady state sweep test may be compared to show the influence that different ternary spinel system may have on TWC performance, particularly under rich condition close to stoichiometric condition. Additionally, catalytic performance of fine grain bulk powder samples including Co—Fe—Mn and Co_Mn—Fe spinels on doped Zirconia support oxide may be qualitatively compared.

According to principles in present disclosure, the ternary spinel system in each group, which shows high level of activity, may be compared with ternary spinel systems from other groups also showing high level of activity to analyze influence on TWC performance for overall improvements that may be developed in the preparation of fine grain bulk powder catalyst material to use for ZPGM catalyst for TWC applications.

Catalyst Performance for Co—Fe—Mn Spinel Catalyst

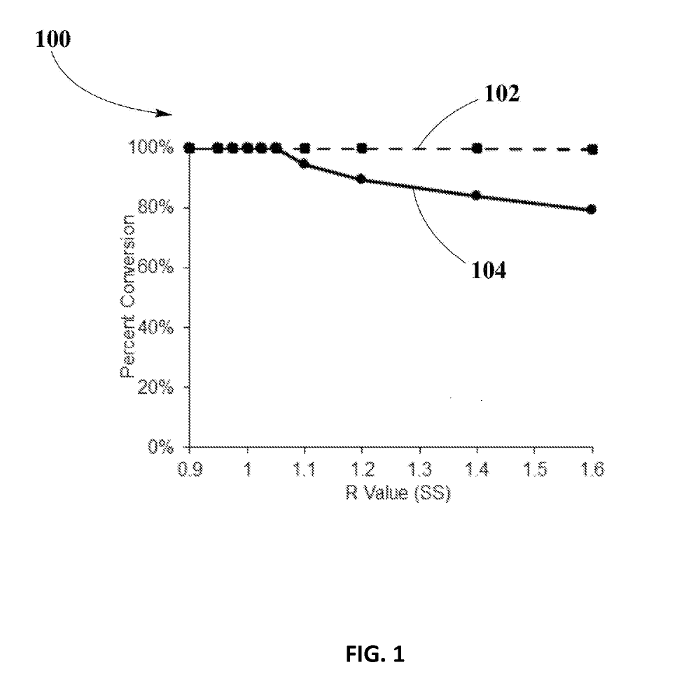

FIG. 1 shows catalyst performance 100 for fine grain bulk powder catalyst samples including Co—Fe—Mn spinel, prepared per example #1, with Co_{0.3}Fe_{0.9}Mn_{1.8}O₄ formulation as shown in Table 1 under isothermal steady state sweep condition, at inlet temperature of about 450° C.

FIG. 1 illustrates results of steady state sweep test for conversion performance of CO, and HC, identified as, CO curve 102 (dash line with square), and HC curve 104 (solid line with round) respectively.

As may be seen in FIG. 1, sweep test results for fine grain bulk powder catalyst samples including Co_{0.3}Fe_{0.9}Mn_{1.8}O₄ spinel shows a very high level of activity for CO and HC conversion with 100% conversion of CO for all range of R values from lean to rich condition. HC conversion is 100% under lean and stoichiometric R values and decrease after R-value >1.05 with conversion of about 80% at R-value=1.6.

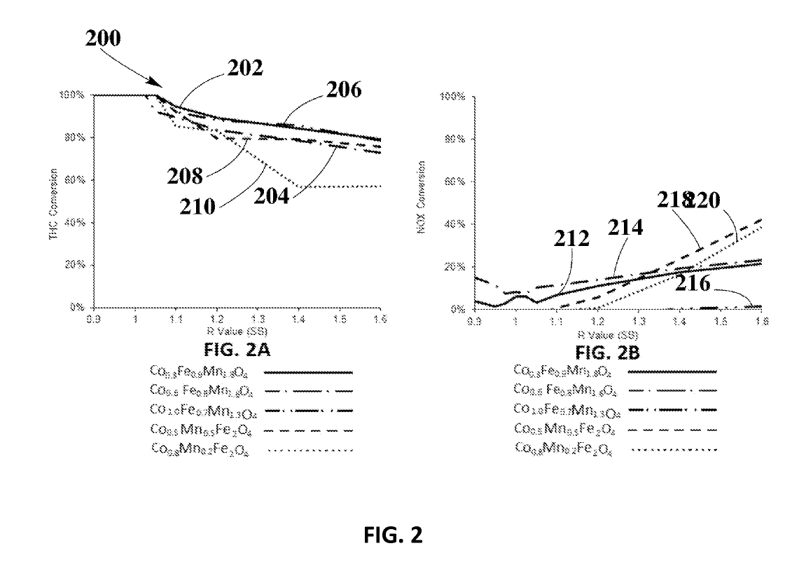

FIG. 2, shows performance comparison 200 of HC conversion and NOx conversion, employing fine grain bulk powder samples including Co—Fe—Mn spinel prepared per example #1 with molar ratios as shown in Table 1, for testing under isothermal steady state sweep condition, at inlet temperature of about 450° C. and SV of about 40,000 h⁻¹, according to an embodiment.

FIG. 2A shows test results for HC percent conversion performance for fine grain bulk powder samples including Co—Fe—Mn spinel which may be identified as conversion curve 202 (solid line), conversion curve 204 (dot and dash line), conversion curve 206 (double dot and dash line), conversion curve 208 (dash line), and conversion curve 210 (dotted line), respectively for Co_{0.3}Fe_{0.9}Mn_{1.8}O₄, Co_{0.6}Fe_{0.8}Mn_{1.6}O₄, Co_{0.0}Fe_{0.7}Mn_{1.3}O₄, Co_{0.5}Mn_{0.5}Fe_{2.0}O₄, and Co_{0.8}Mn_{2.0}Fe_{2.0}O₄.

As may be seen in FIG. 2A, sweep test results shows very high level of performance activity for HC at lean and stoichiometric condition, which decreases after R-value >1.05 for all fine grain bulk powder samples including Co—Fe—Mn spinel formulation from Table 1. CO conversion (not shown here) is 100% for all samples in the whole range of R-values from lean to rich. May be noted that HC conversion is lower for Co₁₋ₓMnₓFe₂O₄ spinel formulation when Fe is in spinel B site.

In FIG. 2B shows sweep test results for NOx percent conversion performance for fine grain bulk powder samples including Co—Fe—Mn spinel, identified as conversion curve 212 (solid line), conversion curve 214 (dot and dash line), conversion curve 216 (double dot and dash line), conversion curve 218 (dash line), and conversion curve 220 (dotted line) respectively for CO_{0.3}Fe_{0.9}Mn_{1.8}O₄, CO_{0.6}Fe_{0.8}Mn_{1.6}O₄, Co_{1.0}Fe_{0.7}Mn_{1.3}O₄, Co_{0.5}Mn_{0.5}Fe_{2.0}O₄, and Co_{0.8}Mn_{2.0}Fe_{2.0}O₄.

In FIG. 2B may be observed that for all fine grain bulk powder samples including Co—Fe—Mn spinel formulation from Table 1, overall NOx conversion performance is low. May be noted on fine grain bulk powder samples including Co—Fe—Mn spinel with (CoₓFe_{z}Mn_{2z})_{3-δ}O₄ formulation, Mn in spinel B site, by increasing Co amount NOx conversion is negatively affected NOx conversion, as shown zero NOx conversion in all R region for Co_{1.0}Fe_{0.7}Mn_{1.3}O₄. For fine grain bulk powder samples with Co₁₋ₓMnₓFe₂O₄ formulations, Fe in spinel B site, shows similar trend, that by increasing Co amount, NOx conversion decreases. Also may be noted when Fe is in spinel B site, NOX conversion is more than Mn in spinel B site. Additionally, fine grain bulk powder catalyst materials including Co Fe—Mn spinel systems may be employed as oxidation catalyst materials for HC/CO activity since low NO_{X} activity may be observed.

### Example #2

### Cu_Fe—Mn Spinel on Doped ZrO₂Support Oxide

Example #2 may illustrate preparation of fine grain bulk powder catalyst samples including Cu—Mn—Fe spinels supported on doped ZrO₂ support oxide via IW method, with CuₓMn_{y}Fe_{z}O₄ formulation where x+y+z=3, according to a plurality of molar ratios, as shown in Table 2.

TABLE 2

| SPINEL COMPOSITION | SUPPORT OXIDE |
|---|---|
| Cu_{1.0}Fe_{1.0}Mn_{1.0}O₄ | Pr₆O₁₁—ZrO₂ |
| Cu_{0.5}Fe_{1.0}Mn_{1.5}O₄ | Pr₆O₁₁—ZrO₂ |
| Cu_{0.5}Mn_{0.5}Fe_{2.0}O₄ | Pr₆O₁₁—ZrO₂ |
| Cu_{0.5}Fe_{0.5}Mn_{2.0}O₄ | Pr₆O₁₁—ZrO₂ |
| Cu_{1.0}Fe_{0.5}Mn_{1.5}O₄ | Pr₆O₁₁—ZrO₂ |

For preparation of fine grain bulk powder samples including each Cu_Fe—Mn spinel composition as shown in Table 2, a solution of corresponding spinel may be mixed with the appropriate amount of nitrate precursors of all elements. To get the right composition for each Cu_Fe—Mn spinel, mix the appropriated amount of nitrate precursor for all elements, including Cu nitrate solution (Cu(NO₃)₂, Fe nitrate (Fe(NO₃)₃) solution, and Mn nitrate solution (Mn(NO₃)₂), which may be mixed with water to make solutions at different molar ratios according to Table 2, where disclosed Cu_Fe—Mn spinels are shown. Then, solution of Cu, Fe, and Mn nitrates may be added to Pr₆O₁₁—ZrO₂ support oxide powder via IW method. Subsequently, mixture of Cu, Fe, and Mn spinels on Pr₆O₁₁—ZrO₂ support oxide may be dried at 120 C over night and calcined at about 800° C. for about 5 hours, and then ground to fine grain bulk powder for preparation of catalyst samples.

The NO/CO cross over R-value of prepared fine grain bulk powder samples, may be determined by performing isothermal steady state sweep test at inlet temperature of about 450° C., at TWC R values from about 1.60 (rich condition) to about 0.90 (lean condition), and SV of about 40,000 h⁻¹, according to an embodiment.

Catalyst Performance for Cu_Fe—Mn Spinel Catalyst

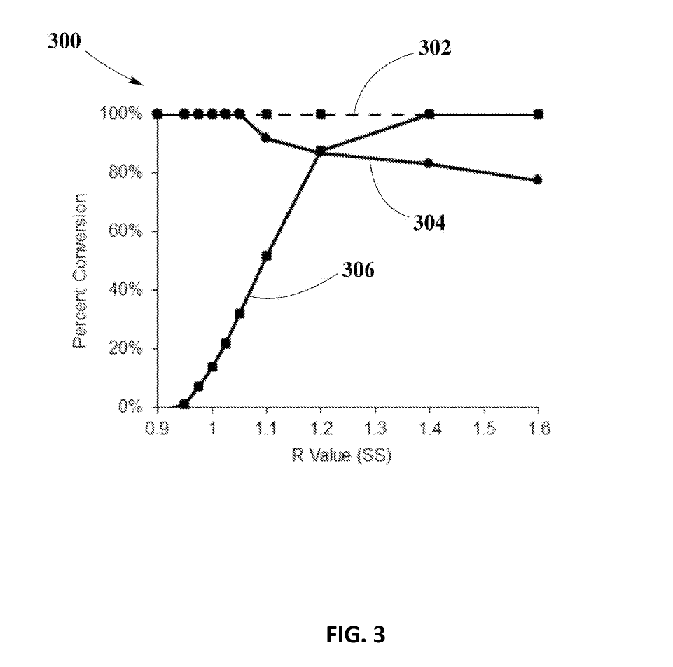

FIG. 3 illustrates catalyst performance 300 for fine grain bulk powder catalyst samples prepared per example #2, with Cu_{1.0}Fe_{1.0}Mn_{1.0}O₄ formulation as shown in Table 2 under isothermal steady state sweep condition, at inlet temperature of about 450° C. and SV of about 40,000 h⁻¹, according to an embodiment.

In FIG. 3, conversion curve 302 (dash line with square), conversion curve 304 (solid line with round), and conversion curve 306 (solid line with square) respectively illustrate isothermal steady state sweep test results for CO conversion, HC conversion, and NO conversion for fine grain bulk powder catalyst samples including Cu_{1.0}Fe_{1.0}Mn_{1.0}O₄ spinel catalyst.

As may be seen in FIG. 3, sweep test results for fine grain bulk powder catalyst samples including Cu_{1.0}Fe_{1.0}Mn_{1.0}O₄ spinel, the NO/CO cross over R-value takes place at the specific R-value of 1.4, where NO_{X} and CO conversions are about 100%, and HC conversion is about 83.03%. It may be also noted that improved level of catalytic activity for NO_{X} conversion may be due to the presence of Cu in the spinel structure.

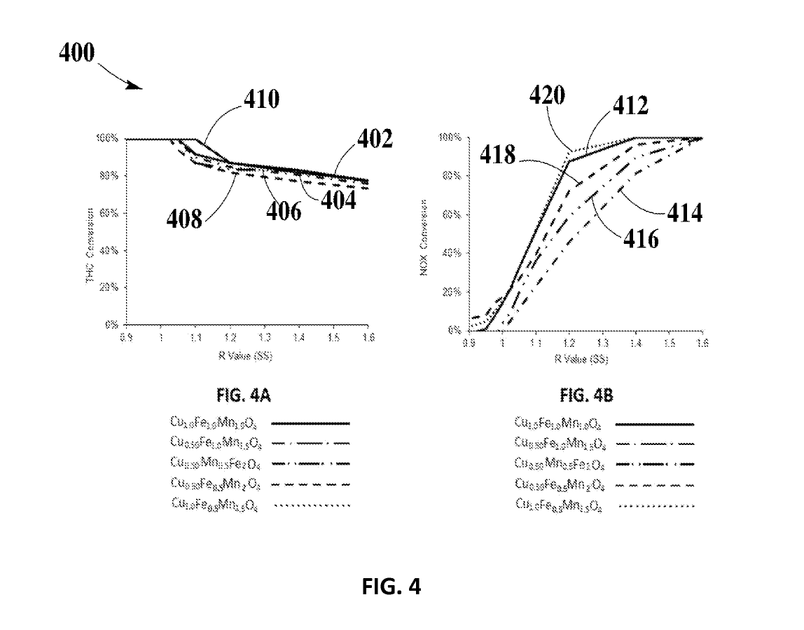

FIG. 4, shows conversion performance comparison 400 of HC conversion and NOx conversion, employing fine grain bulk powder samples including Co—Fe—Mn spinel, which may be prepared according to instructions from Example #2, and molar ratios per Table 2 for testing under isothermal steady state sweep condition, at inlet temperature of about 450° C., and SV of about 40,000 h⁻¹, according to an embodiment. A sweep test indicates the catalyst performance at a plurality of R-values.

FIG. 4A shows sweep test results for HC conversion performance for fine grain bulk powder samples including Cu_Fe—Mn spinel, identified with general formulation as CuₓMn_{y}Fe_{z}O₄ as conversion curve 402 (solid line), conversion curve 404 (dot and dash line), and conversion curve 406 (double dot and dash line), conversion curve 408 (dash line), and conversion curve 410 (dotted line) respectively for Cu_{1.0}Fe_{1.0}Mn_{1.0}O₄, Cu_{0.5}Fe_{1.0}Mn_{1.5}O₄, Cu_{0.5}Mn_{0.5}Fe_{2.0}O₄, Cu_{0.5}Fe_{0.5}Mn_{2.0}O₄, and Cu_{1.0}Fe_{0.5}Mn_{1.5}O₄. CO conversion (not shown here) is 100% for all samples in the whole range of R-values from lean to rich. As may be seen in FIG. 4A, sweep test results shows 100% HC conversion for lean and stoichiometric R-values and decreasing in HC conversion for R-values >1.05 for all Cu_Fe—Mn spinels. Test results also shows no change in HC conversion when Fe is in spinel B site.

FIG. 4B shows sweep test results for NOx percent conversion performance for fine grain bulk powder samples including Cu_Fe—Mn spinel spinel, identified with general formulation as CuₓMn_{y}Fe_{z}O₄ as conversion curve 412 (solid line), conversion curve 414 (dot and dash line), conversion curve 416 (double dot dash line), conversion curve 418 (dash line), and conversion curve 420 respectively for Cu_{1.0}Fe_{1.0}Mn_{1.0}O₄, Cu_{0.5}Fe_{1.0}Mn_{1.5}O₄, Cu_{0.5}Mn_{0.5}Fe_{2.0}O₄, Cu_{0.5}Fe_{0.5}Mn_{2.0}O₄, and Cu_{1.0}Fe_{0.5}Mn_{1.5}O₄ depict steady state sweep test results for NO conversion comparison for fine grain bulk powder catalyst samples.

In FIG. 4B, sweep test results for all fine grain bulk powder samples including Cu_Fe—Mn spinel, the overall NOx conversion is greater than NOx conversion in Co—Fe—Mn system. For Cu_Fe—Mn spinel with Mn in B site shows better performance activity than Cu_Fe—Mn spinel including Fe in B site.

A comparison of test results indicates and verifies that samples including Cu_{1.0}Fe_{1.0}Mn_{1.0}O₄ and Cu_{1.0}Fe_{0.5}Mn_{1.5}O₄ spinel are more effective, exhibiting greater NOx conversion. Also may be observed that lower Fe content may increase NO conversion, operating at R-values of stoichiometric and non-stoichiometric condition, demonstrating better catalytic performance for TWC applications.

Performance Comparison for Co_{0.5}Mn_{0.3}Fe_{2.0}O₄ Spinel and Cu_{1.0}Fe_{0.5}Mn_{1.5}O₄ Spinel Catalysts

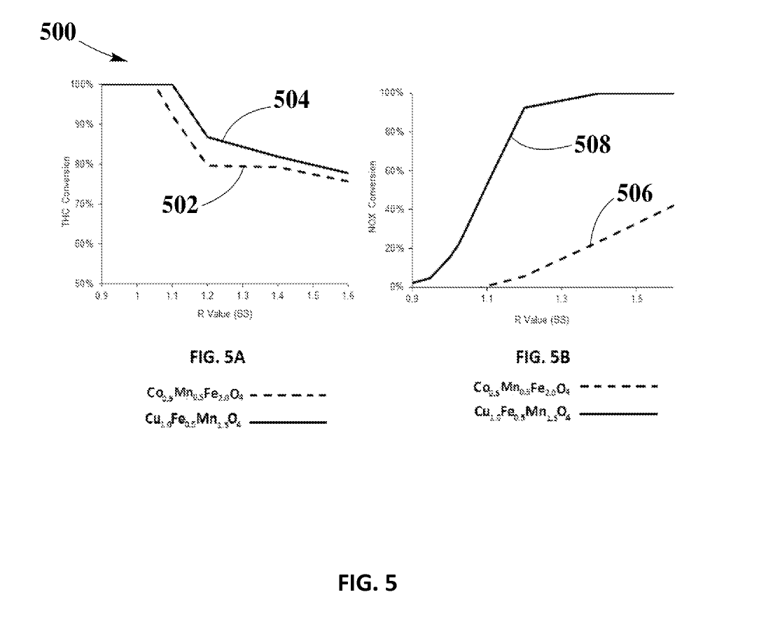

FIG. 5, shows performance comparison 500 of HC conversion and NOx conversion, employing samples with best catalytic performance from each group, including Co_{0.5}Mn_{0.5}Fe_{2.0}O₄ spinel and Cu_{1.0}Fe_{0.5}Mn_{1.5}O₄ spinel, prepared according to process from example #1 and example #2 respectively, and molar ratios per Table 1 and Table 2 for testing under isothermal steady state sweep condition, at inlet temperature of about 450° C. and SV of about 40,000 h⁻¹, according to an embodiment.

FIG. 5A shows sweep test results for HC percent conversions for disclosed ternary spinels including Co_{0.5}Mn_{0.5}Fe_{2.0}O₄ spinel and Cu_{1.0}Fe_{0.5}Mn_{1.5}O₄ spinel, identified respectively as conversion curve 502 (dash line), and conversion curve 504 (solid line). FIG. 5B shows test results for NOx percent conversions for disclosed ternary spinels including Co_{0.5}Mn_{0.5}Fe_{2.0}O₄ spinel and Cu_{1.0}Fe_{0.5}Mn_{1.5}O₄ spinel, identified respectively as conversion curve 506 (dash line), and conversion curve 508 (solid line).

As may be seen in FIG. 5A and FIG. 5B, sweep test results shows very high level of performance activity for HC conversion of 100% for both fine grain bulk powder samples including Cu_{1.0}Fe_{0.5}Mn_{1.5}O₄ spinel and Co_{0.5}Mn_{0.5}Fe_{2.0}O₄ spinel under lean and stoichiometric condition. Also may be observed, that Cu_Fe—Mn spinel achieved the highest level of response for HC conversion at R-value >1.05, for example at R-value=1.2, HC conversion for Cu_{1.0}Fe_{0.5}Mn_{1.5}O₄ is about 86.8%, while for Co_{0.5}Mn_{0.5}Fe_{2.0}O₄ is about 79.5%. May be noticed that spinel catalyst systems including Co in its composition exhibit a decrease of HC conversion, the lowest NOx level of conversion, but the catalyst behavior of ternary spinel system with Cu in its composition exhibit a high level of performance for NOx conversion. For example, at R=1.2, NOx conversion for Cu_{1.0}Fe_{0.5}Mn_{1.5}O₄ is about 92.4%, while for Co_{0.5}Mn_{0.5}Fe_{2.0}O₄ is about 5.7%. CO conversion (not shown here) is 100% for both samples.

A comparison of results of NOx, CO, and HC conversion, indicates and verifies that samples of Cu_{1.0}Fe_{0.5}Mn_{1.5}O₄ spinel shows an improved level of performance for TWC catalytic activities, and are more effective than Co_Mn—Fe spinel.

Fine grain bulk powder catalyst samples including Cu_Fe—Mn spinel and Co_Mn—Fe spinel, both supported on Pr₆O₁₁-ZrO₂ support oxide, may have a positive effect and particularly useful for purifying exhaust gases produced by internal combustion engines, where lean/rich fluctuations in operating conditions may produce high variation in exhaust contaminants that may be removed, achieving improved catalytic activity performance under any operating conditions.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic composition, comprising:
an oxygen storage material, comprising:
Co_Mn—Fe spinel on a doped zirconia support oxide;
wherein the oxygen storage material converts at least one of NO, CO and HC through oxidation or reduction.

2. The composition of claim 1, wherein the Co_Mn—Fe spinel is stoichiometric.

3. The composition of claim 1, wherein the Co_Mn—Fe spinel is non-stoichiometric.

4. The composition of claim 1, wherein the Co_Mn—Fe spinel is applied to the support oxide by incipient wetness (IW) method.

5. The composition of claim 1, wherein the Co_Mn—Fe spinel has the general formula (CoₓFe_{z}Mn_{2z})_{3δ}O₄, wherein Fe/Mn=0.5, x+3z=1, and 0≦δ≦0.2.

6. The composition of claim 1, wherein the Co_Mn—Fe spinel has the general formula Co₁₋ₓMnₓFe₂O₄ wherein 0≦x≦1.

7. The composition of claim 1, wherein the Co_Mn—Fe spinel has the general formula CuₓMn_{y}Fe_{z}O₄ wherein x+y+z=3.

8. The composition of claim 1, wherein the doped zirconia comprises Pr₆O₁₁—ZrO₂.

9. The composition of claim 1, wherein the Fe of the Co_Mn—Fe spinel is in the spinel B site.

10. The composition of claim 1, wherein the oxygen storage material is calcined at about 800° C.

11. The composition of claim 10, wherein the oxygen storage material is calcined for about 5 hours.

12. The composition of claim 1, wherein the Mn of the Co_Mn—Fe spinel is in the spinel B site.

13. A method for making a catalytic composition, comprising:
preparing a solution comprising Co nitrate solution Co(NO₃)₂, Fe nitrate solution (Fe(NO₃)₃) and Mn nitrate solution (Mn(NO₃)₂) with water wherein Co_Mn—Fe spinel is formed;
adding the solution drop-wise to doped Zirconia powder via an incipient wetness method to create a mixture;
drying the mixture at 120° C. for more than 4 hours; and
calcining the mixture at about 800° C. for about 5 hours

14. The method of claim 13, further comprising grounding the mixture into a fine grain powder.

15. The method of claim 13, wherein the Co_Mn—Fe spinel is stoichiometric.

16. The method of claim 13, wherein the Co_Mn—Fe spinel is non-stoichiometric.

17. The method of claim 13, wherein the Co_Mn—Fe spinel has the general formula (CoₓFe_{z}Mn_{2z})_{3δ}O₄, wherein Fe/Mn=0.5, x+3z=1, and 0≦δ≦0.2.

18. The method of claim 13, wherein the Co_Mn—Fe spinel has the general formula Co₁₋ₓMnₓFe₂O₄ wherein 0≦x≦1.

19. The method of claim 13, wherein the Co_Mn—Fe spinel has the general formula CuₓMn_{y}Fe_{z}O₄ wherein x+y+z=3.

20. The method of claim 13, wherein the doped zirconia comprises Pr₆O₁₁—ZrO₂.

21. The method of claim 13, wherein the Fe of the Co_Mn—Fe spinel is in the spinel B site.
